(19) United States
(12) Patent Application Publication
(10) Pub. No.: US 2015/0077212 A1
(43) Pub. Date: Mar. 19, 2015

(54) FUSE

(71) Applicant: YAZAKI CORPORATION, Tokyo (JP)

(72) Inventors: Yusuke MATSUMOTO, Makinohara-shi (JP); Masashi IWATA, Makinohara-shi (JP)

(21) Appl. No.: 14/548,350

(22) Filed: Nov. 20, 2014

Related U.S. Application Data
(63) Continuation of application No. PCT/JP2013/064633, filed on May 27, 2013.

(30) Foreign Application Priority Data
May 31, 2012 (JP) 2012-124706

(51) Int. Cl. H01H 85/044

(52) U.S. Cl. CPC H01H 85/044
USPC 337/187

(57) ABSTRACT

A fuse according to the present invention includes terminal connecting portions connected to a counterpart terminal, and a fusible portion provided between terminal connecting portions and breaking a current not less than a rated current, and the terminal connecting portions and the fusible portion are integrally formed with a conductive plate. The terminal connecting portion includes a main body face and a bent face bent from the main body face and brought into contact with the main body face. The fusible portion includes a fusible conductor portion connecting a pair of the main body faces with each other, low-melting point metal provided on the fusible conductor portion and having a lower melting point than the fusible conductor portion, and a swaging portion for swaging and fixing the low-melting point metal. The swaging portion is bent toward a side of the bent face to fix the fusible conductor portion.

### CROSS REFERENCE TO RELATED APPLICATIONS

This application is a Continuation of PCT Application No. PCT/JP2013/064633, filed on May 27, 2013, and claims the priority of Japanese Patent Application No. 2012-124706, filed on May 31, 2012, the content of both of which is incorporated herein by reference.

### TECHNICAL FIELD

The present invention relates to a fuse, and particularly to a fuse mounted on a vehicle.

### BACKGROUND ART

Conventionally, a vehicle such as a car uses a plurality of fuses to protect electric circuits of various types of electronic devices. Each of such types of fuses includes a pair of terminal connecting portions to be connected to a counterpart terminal, a fusible portion provided between the pair of terminal connecting portions and breaking a current not less than a rated current (i.e., overcurrent), and a cover member covering the fusible portion with a part of the terminal connecting portion being exposed. The terminal connecting portions and the fusible portion are integrally formed with a conductive plate.

Generally, the fusible portion includes a fusible conductor portion connecting the pair of terminal connecting portions with each other, a low-melting point metal provided on the fusible conductor portion and including metal having a lower melting point than the fusible conductor portion (e.g., tin or its alloy), and a swaging portion for swaging and fixing the low-melting point metal.

The swaging portion of the fuse disclosed in the patent literature 1 is formed by rising from the both side edges of the fusible conductor portion, and it is referred to as a so-called open barrel type. The swaging portion is swaged in such a manner as to enclose the low-melting point metal from the both side edges of the fusible conductor portion to fix the low-melting point metal onto the fusible conductor portion.

### CITATION LIST

### Patent Literature

Patent Literature 1: Japanese Patent Laid-Open Publication No. 7-130277

### SUMMARY OF INVENTION

### Technical Problem

However, in the fuse disclosed in the patent literature 1, since the swaging portion is swaged in such a manner as to enclose the low-melting point metal from the both side edges of the fusible conductor portion, the low-melting point metal and the swaging portion are protruded from the fusible conductor portion, thereby making the fuse larger. Therefore, it has been desired to make as less as possible an amount of protrusion of the low-melting point metal and the swaging portion from the fusible conductor portion.

Thus, it is an object of the present invention to provide a fuse capable of reducing the amount of the protrusion of the low-melting point metal and the swaging portion from the fusible conductor portion to realize miniaturization.

### Solution to Problem

To solve the above described problem, the present invention has features described as below. First, a first feature of the present invention is a fuse including a pair of terminal connecting portions to be connected to a counterpart terminal and a fusible portion provided between the pair of terminal connecting portions and breaking a current not less than a rated current; the pair of the terminal connecting portions and the fusible portion being integrally formed with a conductive plate; each of the terminal connecting portions includes a main body face and a bent face bent from the main body face and brought into contact with the main body face; and the fusible portion includes a fusible conductor portion connecting a pair of the main body faces with each other, a low-melting point metal provided on the fusible conductor portion and having a lower melting point than the fusible conductor portion, and a swaging portion for swaging and fixing the low-melting point metal, in which the swaging portion is bent toward a side of the bent face to fix the fusible conductor portion.

According to the above described feature, the swaging portion is bent toward a side of the bent face to fix the fusible conductor portion. With this arrangement, compared with a case where the swaging portion is bent toward an opposite side of the bent face, the swaging portion can have a thickness much closer to that of the terminal connecting portion (main body face and bent face). Therefore, the amount of the protrusion of the low-melting point metal and the swaging portion from the bent face can be reduced, thereby realizing miniaturization of the fuse.

In addition, the terminal connecting portion includes the main body face and the bent face bent from the main body face and brought into contact with the main body face. With this arrangement, even when a thickness of a plate used to manufacture the fuse is made thinner to realize a lighter fuse, rigidity of the terminal connecting portion can be ensured.

A second feature of the present invention is the fuse according to the first feature of the present invention, wherein the terminal connecting portion is formed long along a direction orthogonal to an extending direction of the fusible conductor portion; and wherein the swaging portion is formed with a swaging piece protruded along the terminal connecting portion from both side edges of the fusible conductor portion, and is swaged in such a manner as to enclose the low-melting point metal from the both side edges of the fusible conductor portion.

According to the above described feature, the swaging portion is formed with a swaging piece and is swaged in such a manner as to enclose the low-melting point metal from the both side edges of the fusible conductor portion. With this arrangement, compared with a case where the swaging portion encloses the low-melting point metal from one side edge of the fusible conductor portion, the low-melting point metal can be fixed more reliably.

A third feature of the present invention is the fuse according the first or second feature of the present invention, and the main body face includes an inside edge portion to which the fusible conductor portion is connected and an outside edge portion located at an outside of the inside edge portion being opposed to the inside edge portion, wherein the bent face is connected to the outside edge portion.

According to the above described feature, the bent face is connected to the outside edge portion. With this arrangement, when the plate used to manufacture the fuse is punched out, the plate can be used more efficiently when compared with a case where the bent face is connected to an upper side portion or a lower side portion. Therefore, unnecessary part of the plate can be reduced, thereby reducing a manufacturing cost of the fuse.

A fourth feature of the present invention is the fuse according to the first or second feature of the present invention, in which the main body face includes an inside edge portion to which the fusible conductor portion is connected, an outside edge portion located at an outside of the inside edge portion being opposed to the inside edge portion, and a side portion connecting the inside edge portion with the outside edge portion; and the bent face is connected to the side portion.

According to the above described feature, the bent face is connected to a side portion. In other words, a leading end of the terminal connecting portion in an insertion direction to the counterpart terminal is formed on a bent face. With this arrangement, the terminal connecting portion can be easily inserted into the counterpart terminal. Therefore, an insertion force of the terminal connecting portion to the counterpart terminal is reduced, thereby easily mounting the fuse to the counterpart terminal.

### BRIEF DESCRIPTION OF DRAWINGS

FIG. 1 is a perspective view illustrating a fuse according to the present embodiment.

FIG. 2 is an exploded perspective view illustrating the fuse according to the present embodiment.

FIG. 3A is a front view of the fuse according to the present embodiment.

FIG. 3B is a plan view of the fuse according to the present embodiment.

FIG. 3C is a side view of the fuse according to the present embodiment.

FIG. 4A is a front view of a terminal connecting portion and a fusible portion according to the present embodiment.

FIG. 4B is a plan view of a terminal connecting portion and a fusible portion according to the present embodiment.

FIG. 4C is a side view of a terminal connecting portion and a fusible portion according to the present embodiment.

FIG. 5 is an exploded view illustrating the terminal connecting portion and the fusible portion according to the present embodiment.

FIG. 6A is a perspective view of the terminal connecting portion and the fusible portion according to a modification example.

FIG. 6B is an expanded view of the terminal connecting portion and the fusible portion according to a modification example.

### DESCRIPTION OF EMBODIMENTS

Next, with reference to drawings, the embodiments of the fuse according to the present invention will be described. In the descriptions in the drawings illustrated below, same or similar reference numerals are provided to same or similar parts. However, the drawings are schematically illustrated, and thus it should be noted that ratios of dimensions are different from actual ones. Therefore, specific dimensions should be determined in consideration of descriptions described below. Further, the diagrams may include parts having mutually different relationships in dimensions and ratios.

(Structure of Fuse)

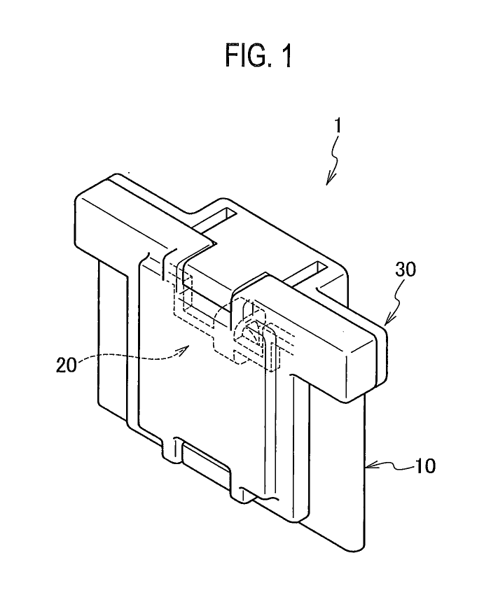

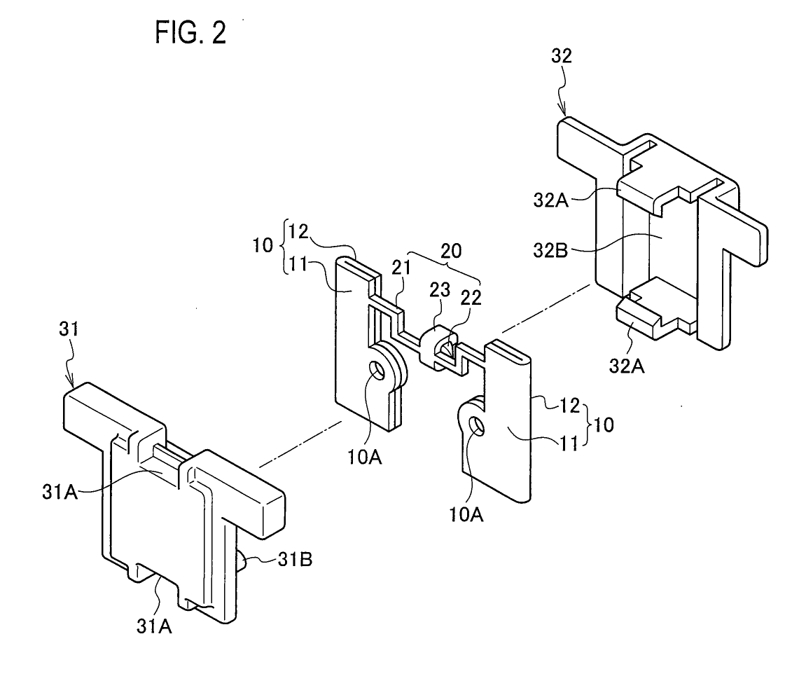

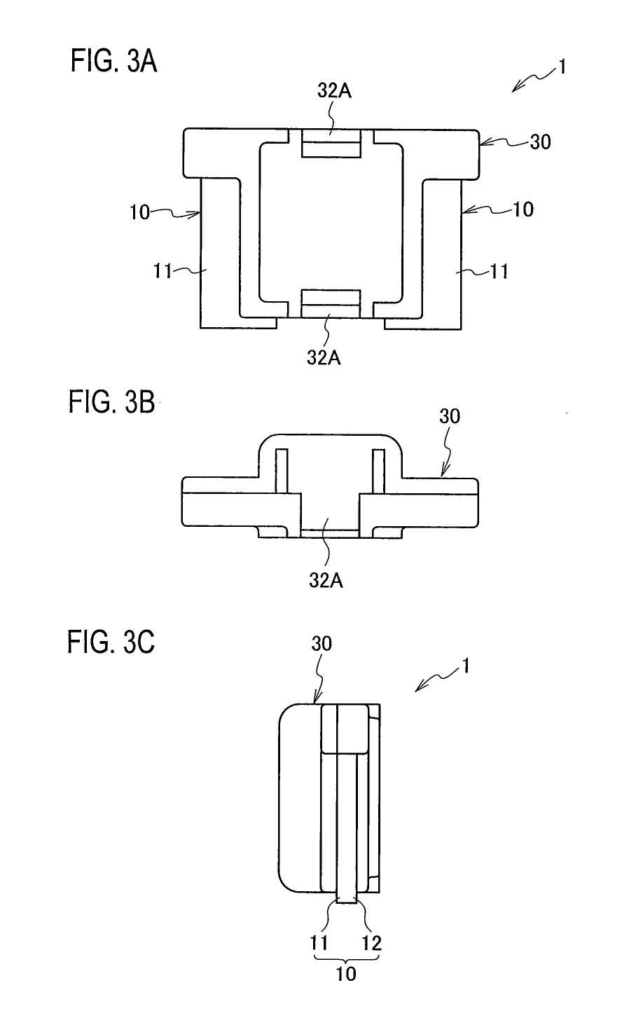

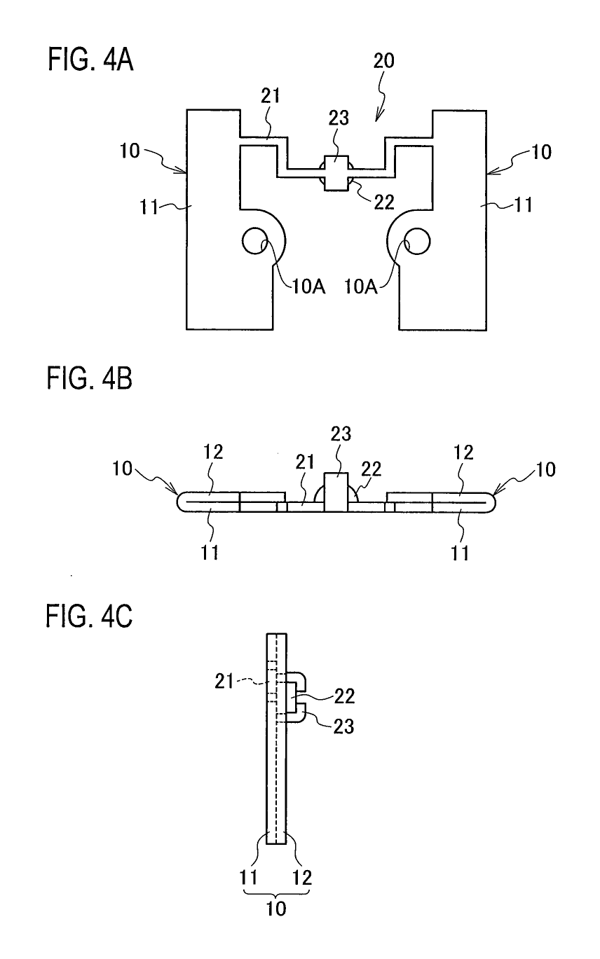

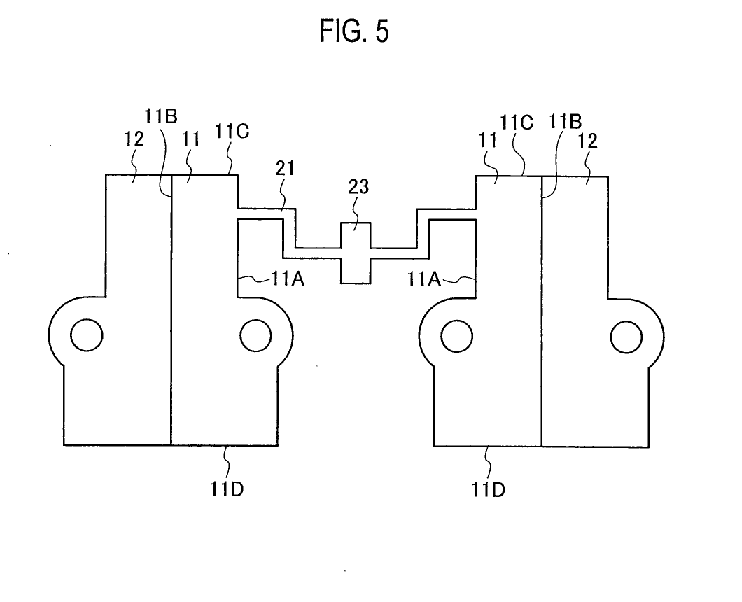

First, with reference to the drawings, the structure of a fuse 1 according to the present embodiment will be described. FIG. 1 is a perspective view illustrating the fuse 1 according to the present embodiment. FIG. 2 is an exploded perspective view illustrating the fuse 1 according to the present embodiment. FIGS. 3A to 3C illustrate the fuse 1 according to the present embodiment, in which FIG. 3A is a front view, FIG. 3B is a plan view, and FIG. 3C is a side view. FIGS. 4A to 4C illustrate a terminal connecting portion 10 and a fusible portion 20 according to the present embodiment, in which FIG. 4A is a front view, FIG. 4B is a plan view, and FIG. 4C is a side view. FIG. 5 is an exploded view illustrating the terminal connecting portion 10 and the fusible portion 20 according to the present embodiment. The fuse 1 according to the present embodiment is connected to a counterpart terminal (e.g., diapason terminal) (not illustrated).

As illustrated in FIG. 1 to FIGS. 3A to 3C, the fuse 1 includes a pair of terminal connecting portions 10 to be connected to the counterpart terminal, the fusible portion 20 integrally formed with the pair of terminal connecting portions 10 and breaking a current not less than a rated current (i.e., overcurrent), and a cover member 30 covering the fusible portion 20 with a part of the terminal connecting portion 10 being exposed. The terminal connecting portions 10 and the fusible portion 20 described above are integrally formed with a conductive plate (refer to FIG. 5).

More specifically, each terminal connecting portion 10 is formed long along a vertical direction. Each terminal connecting portion 10 is formed with a fixing hole 10A (refer to FIG. 2) through which each terminal connecting portion 10 is fixed to the cover member 30. Each terminal connecting portion 10 includes, as illustrated in FIGS. 4A to 4C and FIG. 5, a main body face 11 connected to the fusible portion 20 (fusible conductor portion 21 described below) and a bent face 12 bent from the main body face 11 and brought into contact with the main body face 11.

The main body face 11 includes an inside edge portion 11A to which the fusible portion 20 (fusible conductor portion 21 described below) is to be connected, an outside edge portion 11B located at an outside (a left side or a right side in the drawing) from the inside edge portion 11A being opposed to the inside edge portion 11A, and side portions (an upper side portion 11C and a lower side portion 11D) connecting the inside edge portion 11A and the outside edge portion 11B.

The bent face 12 has an approximately same shape with that of the main body face 11. As illustrated in FIG. 5, the bent face 12 is connected to the outside edge portion 11B of the main body face 11.

The fusible portion 20 includes, as illustrated in FIGS. 4A to 4C and FIG. 5, a fusible conductor portion 21 connecting a pair of main body faces 11 with each other, a low-melting point metal 22 provided at the fusible conductor portion 21 and including metal having a lower melting point than the fusible conductor portion 21 (e.g., tin or its alloy), and a swaging portion 23 for swaging and fixing the low-melting point metal 22.

The swaging portion 23 is, as illustrated in FIGS. 4A to 4C and FIG. 5, bent toward the side of the bent face 12 to fix the fusible conductor portion 21. The swaging portion 23 is formed with the swaging piece protruded from the both side edges of the fusible conductor portion 21 along an extending direction of the terminal connecting portion 10. The swaging portion 23 is swaged in such a manner as to enclose the low-melting point metal 22 from the both side edges of the fusible conductor portion 21.

The cover member 30 is, as illustrated in FIG. 1 to FIGS. 3A to 3C, formed in a substantially T-like shape. The cover member 30 includes an upper cover 31 and a lower cover 32 to be mounted to the upper cover 31. Each of side edges (upper and lower side edges) of the upper cover 31 is formed with a locking recessed portion 31A. A face at a side of the terminal connecting portion 10 of the upper cover 31 is formed with a protruding portion 31B to be inserted into a fixing hole 10A of the terminal connecting portion 10. On the other hand, each of side edges (upper and lower side edges) of the lower cover 32 is formed with a locking claw portion 32A to be engaged with the locking recessed portion 31A. Between the locking claw portions 32A, a viewing window 32B that is capable of viewing the fusible portion 20 is formed.

(Operation and Effect)

According to the above described present embodiment, the swaging portion 23 is bent toward the side of the bent face 12 to fix the fusible conductor portion 21. With this arrangement, compared with a case where the swaging portion 23 is bent toward an opposite side of the bent face 12, the swaging portion 23 can have a thickness much closer to a thickness of the terminal connecting portion 10 (main body face 11 and bent face 12). Therefore, the amount of the protrusion of the low-melting point metal 22 and the swaging portion 23 from the bent face 12 can be reduced, thereby realizing miniaturization of the fuse 1.

In addition, the terminal connecting portion 10 includes the main body face 11 and the bent face 12 bent from the main body face 11 and brought into contact with the main body face 11. With this arrangement, even when a thickness of a plate used to manufacture the fuse 1 is made thinner to realize a lighter fuse 1, rigidity of the terminal connecting portion 10 can be ensured.

According to the present embodiment, the swaging portion 23 is formed with the swaging piece and swaged in such a manner as to enclose the low-melting point metal 22 from the both side edges of the fusible conductor portion 21. With this arrangement, compared with a case where the swaging portion 23 encloses the low-melting point metal 22 from one side edge of the fusible conductor portion 21, the low-melting point metal 22 can be fixed more reliably.

According to the present embodiment, the bent face 12 is connected to the outside edge portion 11B. With this arrangement, when the plate used to manufacture the fuse 1 is punched out, the plate can be used more efficiently when compared with a case where the bent face 12 is connected to an upper side portion 11C or a lower side portion 11D. Therefore, unnecessary part of the plate can be reduced, thereby reducing a manufacturing cost of the fuse.

In addition, each terminal connecting portion 10 is formed long along a vertical direction, and the bent face 12 is accordingly connected to the outside edge portion 11B that is longer than the upper side portion 11C or the lower side portion 11D. Therefore, a fixing strength between the main body face 11 and the bent face 12 is increased, thereby reliably improving the rigidity of the terminal connecting portion 10.

(Modification Example)

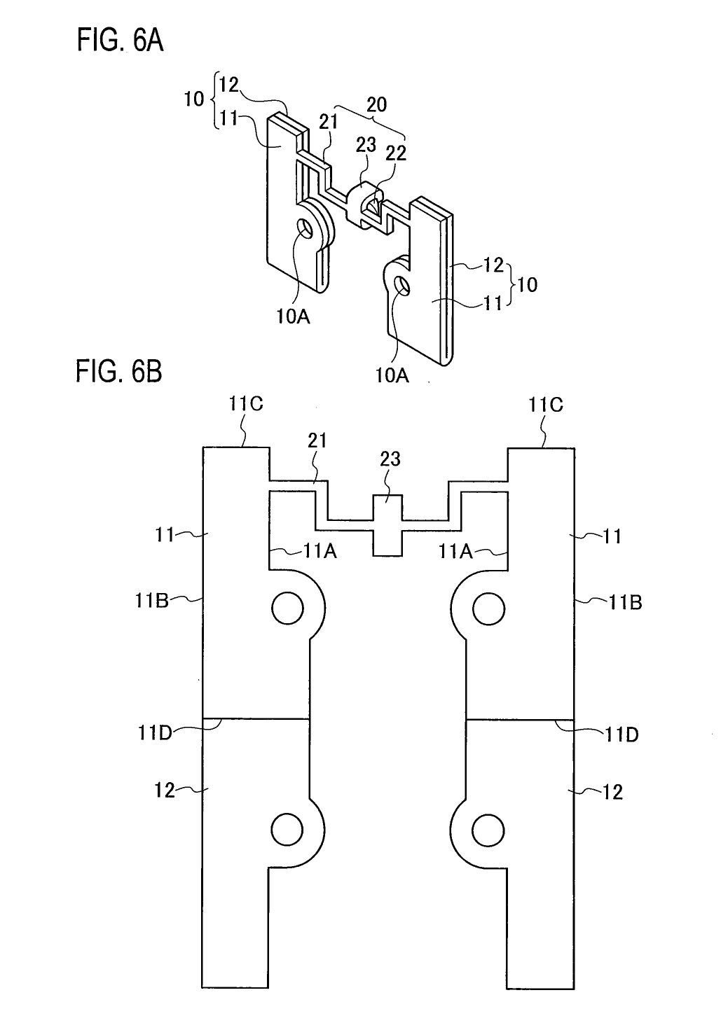

Next, with reference to the drawings, a modification example of the terminal connecting portion 10 according to the above described embodiment will be described. FIGS. 6A and 6B illustrate the terminal connecting portion 10 and the fusible portion 20 according to the modification example, in which FIG. 6A is a perspective view and FIG. 6B is an exploded view. The same reference numeral is provided to a part same as that in the terminal connecting portion 10 according to the above described embodiment and only different parts are mainly described.

According to the above described embodiment, the bent face 12 of the terminal connecting portion 10 is connected to the outside edge portion 11 B of the main body face 11. On the other hand, according to the modification example, as illustrated in FIG. 6B, the bent face 12 of the terminal connecting portion 10 is connected to the lower side portion 11D of the main body face 11.

Even in such a modification example, in a similar manner to the above described embodiment, a lighter fuse 1 can be realized, and even when the thickness of the plate to manufacture the fuse 1 is reduced to realize the lighter fuse 1, the rigidity of the terminal connecting portion 10 can be ensured.

In addition, according to the modification example, the bent face 12 is connected to the lower side portion 11D of the main body face 11. In other words, a leading end of the terminal connecting portion 10 in an insertion direction to the counterpart terminal is formed on a bent face. With this arrangement, the terminal connecting portion 10 can be easily inserted into the counterpart terminal. Therefore, an insertion force of the terminal connecting portion 10 into the counterpart terminal is reduced, thereby easily mounting the fuse 1 to the counterpart terminal.

(Other Embodiments)

As described above, the description of the present invention is disclosed according to the embodiments of the present invention. However, it should not be interpreted that the descriptions and drawings included in a part of the disclosure limits the present invention. Based on the disclosure, various types of alternative embodiments, examples, and operation techniques will be clarified to those skilled in the art.

For example, the embodiment of the present invention can be modified as follows. More specifically, it is described that the swaging portion 23 is formed with the swaging piece protruded along the vertical direction of the terminal connecting portion 10 from the both side edges of the fusible conductor portion 21, but, the swaging portion 23 is not limited thereto, and it may be formed with the swaging piece protruded to one side of the terminal connecting portion 10.

Further, it is described that the bent face 12 of the terminal connecting portion 10 is connected to the outside edge portion 11B or the lower side portion 11D, but, the bent face 12 is not limited thereto, and it may be connected to the upper side portion 11C.

As described above, the present invention may include various types of embodiments that are not described herein. Therefore, a technical scope of the present invention is defined only by specific matters of the invention according to an appropriate scope of claims based on the above described descriptions.

### INDUSTRIAL APPLICABILITY

According to the features of the present invention, it is possible to provide a fuse that can reduce the amount of the protrusion of the low-melting point metal and the swaging portion from the fusible conductor portion to realize miniaturization.

### REFERENCE SIGNS LIST

1 fuse
10 terminal connecting portion
10A fixing hole
11 main body face
11A inside edge portion
11B outside edge portion
11C upper side portion
11D lower side portion
12 bent face
20 fusible portion
21 fusible conductor portion
22 low-melting point metal
23 swaging portion
30 cover member
31 upper cover
31A locking recessed portion
31B protruding portion
32 lower cover
32A locking claw portion
32B viewing window

1. A fuse comprising:
a pair of terminal connecting portions to be connected to a counterpart terminal; and
a fusible portion provided between the pair of terminal connecting portions and breaking a current not less than a rated current, the pair of terminal connecting portions and the fusible portion being integrally formed with a conductive plate,
wherein each of the terminal connecting portions includes a main body face and a bent face bent from the main body face and brought into contact with the main body face,
wherein the fusible portion includes a fusible conductor portion connecting a pair of the main body faces with each other, a low-melting point metal provided on the fusible conductor portion and having a lower melting point than the fusible conductor portion, and a swaging portion for swaging and fixing the low-melting point metal, and
wherein the swaging portion is bent toward a side of the bent face to fix the fusible conductor portion.

2. The fuse according to claim 1, wherein:
the terminal connecting portion is formed long along a direction orthogonal to an extending direction of the fusible conductor portion; and
the swaging portion is formed with a swaging piece protruded along the terminal connecting portion from both side edges of the fusible conductor portion, and is swaged in such a manner as to enclose the low-melting point metal from the both side edges of the fusible conductor portion.

3. The fuse according to claim 1, wherein:
the main body face includes an inside edge portion to which the fusible conductor portion is connected and an outside edge portion located at an outside of the inside edge portion being opposed to the inside edge portion; and
the bent face is connected to the outside edge portion.

4. The fuse according to claim 1, wherein:
the main body face includes an inside edge portion to which the fusible conductor portion is connected, an outside edge portion located at an outside of the inside edge portion being opposed to the inside edge portion, and a side portion connecting the inside edge portion and the outside edge portion; and
the bent face is connected to the side portion.

5. The fuse according to claim 2, wherein:
the main body face includes an inside edge portion to which the fusible conductor portion is connected and an outside edge portion located at an outside of the inside edge portion being opposed to the inside edge portion; and
the bent face is connected to the outside edge portion.

6. The fuse according to claim 2, wherein:
the main body face includes an inside edge portion to which the fusible conductor portion is connected, an outside edge portion located at an outside of the inside edge portion being opposed to the inside edge portion, and a side portion connecting the inside edge portion and the outside edge portion; and
the bent face is connected to the side portion.
